(19) United States
(12) Patent Application Publication
(10) Pub. No.: US 2005/0230304 A1
(43) Pub. Date: Oct. 20, 2005

(54) Filter for using in aerosol paint cans

(76) Inventor: Peter Kwasny, Schaffhausen (CH)

Correspondence Address: FULBRIGHT AND JAWORSKI LLP, 555 S. FLOWER STREET, 41ST FLOOR, LOS ANGELES, CA, 90071, US

(21) Appl. No.: 10/494,200

(22) PCT Filed: Nov. 29, 2002
(86) PCT No.: PCT/EP02/13498

§ 371 Date: Jun. 8, 2005

(30) Foreign Application Priority Data
Nov. 29, 2001 (DE) 101 58 431.8

(51) Int. Cl. B01D 35/027

(52) U.S. Cl. 210/459; 210/473; 210/497.3; 210/499

(57) ABSTRACT

The invention relates to a filter for using in pressurized aerosol paint cans. The inventive filter comprises a body (1), an adapter (2) for fixing an ascending pipe (3), and a filter element (4) said filter element having a permeability of between 20 and 250 μm.

The invention relates to a filter with a filter body, an adapter for fixing an ascending pipe and a filter element, said filter being intended for use in pressurized aerosol paint cans.

Aerosol paint cans have been in use for a long time for various application purposes and different materials and are marketed in great number to satisfy the demands linked with domestic and do-it-yourself uses as well as professional applications. A major portion of these aerosol paint cans is increasingly in demand in the domestic and do-it-yourself sector and above all is needed for automotive repair purposes where they are known for a long time.

Varnishes for automotive repair purposes are sold in the form of one-component and two-component paint systems in pressurized spray cans. In case of two-component paints the paint preparation is blended with a curing component immediately before the paint system is used, with the curing agent bringing about by cross-linking a more or less rapid hardening of the paint coat applied to a surface. Within the aerosol paint can the curing component is accommodated in a second container (inner or cross-linking casing) which can be opened by external action usually by means of a push-rod mechanism arranged in the can bottom so that the contents is allowed to mix with the paint component. After thorough mixing the curing effect takes place as a result of a chemical reaction. For example, epoxy paint systems are known that are cross-linked with a polyamine, and paints with free hydroxy functions which are cross-linked with the aid of polyisocyanates. These cross-linking reactions are known per se and have been described in literature many times.

Particularly with cans having been stored for longer periods problems arise when applying the paint in that particles which have formed in the paint material will significantly impair the smooth appearance of the painted surface. Larger particles may even cause the valve mechanism to become blocked. Problems of this kind in particular arise more often than not with two-component aerosol paint cans where deposits may form as a result of the cross-linking component being accommodated in the inner casing and the pressure balancing taking place between the cross-linking casing and the can interior after filling, said deposits stemming from reactions between minor amounts of the cross-linking agent and the paint component. Such deposits may be released when the inner casing is opened, usually by forcing off a cover by means of a push rod passing through the can bottom, said deposits may then enter the spray valve and/or the paint material discharged. The former leads to irregularities in the paint material spray jet upon discharging or blocking of the spray valve, the latter to an untidily painted surface.

For that reason, a mechanism is needed by means of which undesired particles are retained, particularly in aerosol paint cans.

However, what must be borne in mind when designing a suitable retention mechanism is that the discharge rate, i.e. the amount of, for example, a two-component paint material in relation to time, must not be unduly restricted. Therefore, the retention mechanism must be sufficiently permeable to the paint material and its surface area must be large enough to still enable, even when covered to some extent by retained particles, an adequate amount of paint material to be discharged. The retention mechanism must remain fully functional at a pressure of up to 12 bar usually existing in pressurized cans and show inertness with respect to the solvents, paint constituents and reactive cross-linking agents. Necessary, therefore, is a sufficiently large surface of the retention mechanism having a permeability or pore size suitable for the purpose described above, said permeability or pore size still being passable for the paint constituents after admixture of the cross-linking agent and commencement of the cross-linking reaction, but at the same time being suitable to reliably retain the deposits and incrustations present in the paint can. The retention mechanism should also be designed in such a way that a cross-linking reaction taking place within the can will not cause the pores to close.

This objective is reached with a filter of the above mentioned design, with a filter element having a permeability ranging between 20 and 250 μm, particularly in the range from 40 to 200 μm and, especially preferred, in the range from 60 to 100 μm. In case the permeability is less than 20 μm a satisfactory passage of material to be filtered is no longer ensured. With a permeability in excess of 250 μm, in particular of more than 200 μm, incrustations and deposits are no longer reliably retained but instead are permitted to enter the filter element and may lead to clogging either in the element or in the valve. Especially in the discharged paint material particles of this size will result in an undesirable and improper appearance. Particularly preferred is a permeability that ranges between 60 and 100 μm because this will make sure that both the filter is sufficiently permeable to the paint material and particles of an unacceptable size are intercepted.

In accordance with a preferred embodiment of the invention the filter body has the form of a bell which is closed off with a screening element at the bottom. Said bell has a relatively wide opening (closed off by the screening element) that allows the medium to be filtered to pass through with sufficient ease even when to some extent covered by particles. Accordingly, the bell serves the purpose of widening for the filtering operation the anyway existing opening of the ascending pipe.

The bell is preferably manufactured of a thermoplastic plastic material, for example polyamide, polyethylene or polypropylene. The same applies to the screening element that may, for instance, consist of a filter mesh having a permeability as stated above. Bell and screening element are expediently made of compatible materials that can be connected with each other by welding, for example using ultrasonic methods.

In accordance with an alternative embodiment the body of the filter in itself constitutes the filter element and consists of a sintered material. Sintered materials as can be manufactured, for example, from polyalkylenes of a very high molecular weight are particularly suited. The preferred material is a polyethylene of an ultra-high molecular weight (Poroplast) and a specific density between 0.92 and 0.95 g/cm³, with the mean molecular weight (weighted average) ranging between 3 mill. and 6 mill. g/mol. Filter elements or, more precisely, filter candles of this kind are made from plastic granulate or powder by a sintering process at temperatures in the range of 200° C. The respective filtration properties achieved are the result of the grain size of the raw material, the thickness of the filtration layer, the processing temperature and the processing duration. The relevant techniques and parameters are per se known to those skilled in the art and can be determined by simple tests or experiments.

The advantage of such a filter candle is that the entire surface is available for the filtration process and the filtered material collects in a well in the interior of the filter candle before it is discharged. In this manner sufficient paint material will always be available for discharge in the area of the ascending pipe in aerosol paint cans, with the pressure inside the can which as a rule is at least 3.5 bar being used both for filtration purposes and for the discharge of the paint material.

The filter according to the invention is equipped with an adapter provided for the attachment of an ascending pipe. This adapter may either be part of the filter element proper or a second component that is connected to the filter element. Expediently, the adapter is provided with a hose connection nipple fitted with a sealing rib which enables the ascending pipe leading to the valve located in the pressurized can to be safely and tightly held in position. Unless the adapter forms an integral part of the filter itself it is connected with the filter element by means of a web or arresting facility, for example in such a manner that the filter body or the filter element has an annular recess into which the adapter provided with an appropriately shaped projection engages. Especially preferred in this case is that the projection of the adapter and likewise the recess in the filter body or filter element have a conical configuration.

Expediently, the adapter is made of a thermoplastic plastic material, for example of a polyamide or polyethylene material.

The filters according to the invention have proved especially suitable for two-component aerosol paint cans where they are connected to the valve unit of the can via an ascending pipe. As described above, cans of this kind are equipped with an inner casing, which can be forced open, usually located in the bottom section, with the inner casing containing the cross-linking component, for example a polyamine or polyisocyanate, and, as the case may be, a catalyst. In particular if polyisocyanates are used as cross-linking agent incrustations may as a rule form during the shelf life, and such incrustations must be kept from entering the paint material to be discharged.

The invention is explained in more detail by way of the enclosed figures. They show:

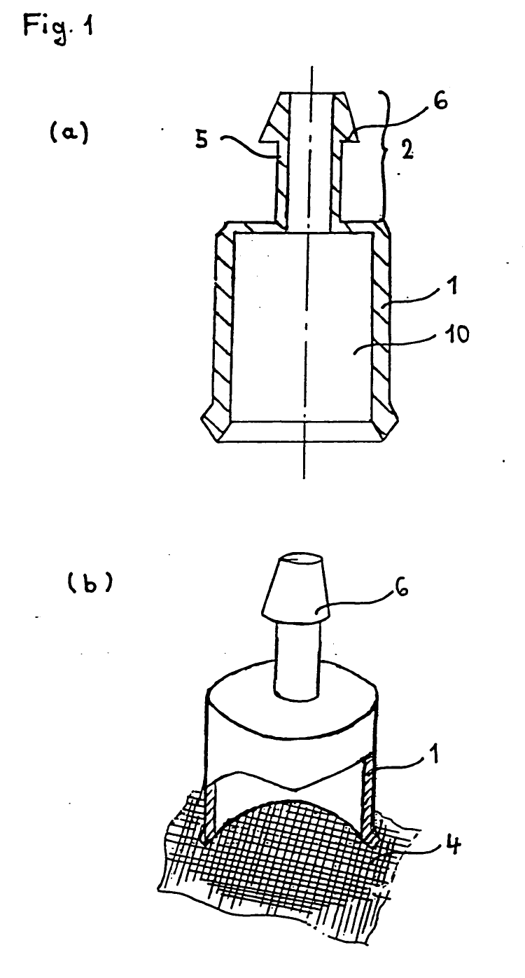

FIG. 1 a filter in accordance with the invention hat has a bell-shaped filter body closed off by means of mesh material (gauze);

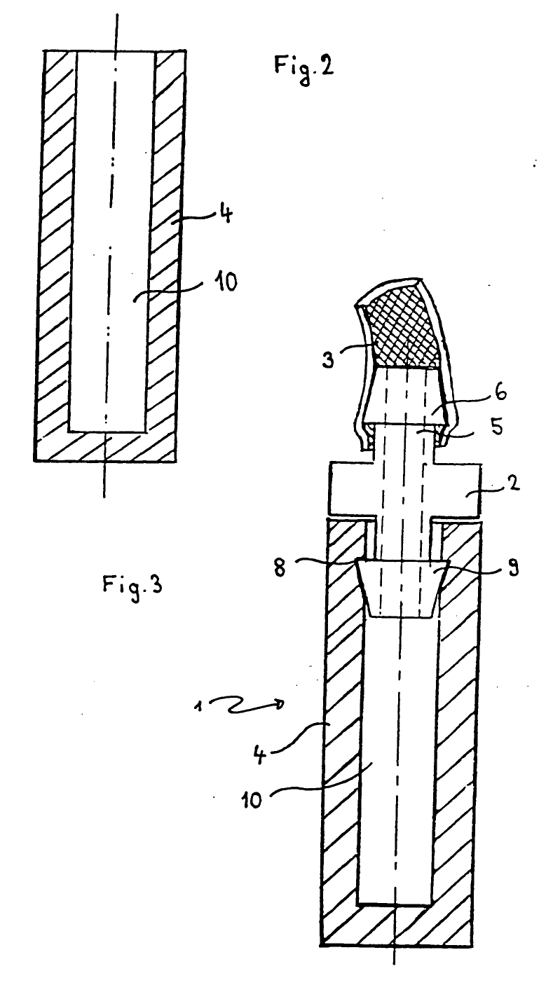

FIG. 2 a filter element made of a sintered plastic material and

FIG. 3 an embodiment of a filter in accordance with the invention being provided with a filter element as per FIG. 2 and an adapter with attached ascending pipe.

FIG. 1(a) shows a filter in accordance with the invention that is provided with a filter basket 1 and an adapter portion 2. The filter basket 1 has the shape of a bell open at the bottom said open space continuing via the interior space 10 and through the adapter portion 2. Adapter 2 has the form of a hose connection nipple the end of which forming a conically shaped sealing rib 6 which enables a plastic hose drawn over it and functioning as ascending pipe to be safely and tightly attached.

As shown in FIG. 1(b) the filter body or filter bell 1 is closed off at its open end by means of filtering gauze/mesh 4, in the present case by making use of an ultrasonic welding method. The gauze material, for example, has a permeability ranging between 40 and 200 μm.

With reference to the present invention the term permeability shall be understood such that particles of a larger diameter are reliably retained, for example if permeability is referred to as 100 μm all particles having a size of more than 100 μm are to be retained.

FIG. 2 shows a filter element 4 in accordance with a second, preferred embodiment of the invention. The filter element consists of a sintered polyethylene of an average molecular weight in the range from 3 mill. to 6 mill. said element having a permeability of 80 μm after the sintering process has been completed at approximately 200° C. The filter element itself, for example, has a total length of 27 mm, an outer diameter of 9 mm and a wall thickness of 2 mm. The filtering effect is achieved over the entire outer surface. The inner space 10 fills with filtered paint material that can be discharged from a pressurized can via an ascending pipe and a valve. The adapter accommodating the ascending pipe is mounted at the upper open end, as is shown in FIG. 3.

In FIG. 3 a filter according to the invention is illustrated having a filter element as shown in FIG. 2 with the adapter 2 in mounted position. Filter body 1 and filter element 4 in this case form an integral unit, the adapter 2 being separated from the filter body proper and provided with a hose connection nipple 5 with a conically shaped sealing rib 6 over which the hose of the ascending pipe 3 is drawn. At the end pointing to the filter side the adapter 2 has another projection or sealing rib 9 that is of tapered configuration towards the end and engages in a plug-in or arresting manner with a correspondingly formed out undercut or recess 8 of the filter element 4 and in this way connects the adapter 2 tightly with the filter element 4.

1. Filter for use in pressurized aerosol paint cans having a body (1), an adapter (2) for the fixation of an ascending pipe (3) and a filter element (4), characterized in that the filter element has a permeability ranging between 20 and 250 μm.

2. The filter according to claim 1, characterized in that the body (1) has the shape of a bell that is closed off by a screening element (4).

3. The filter according to claim 2, characterized in that the screening element (4) is made of filtering gauze.

4. The filter according to claims 2 or 3, characterized in that the filter bell (1) consists of a plastic material.

5. The filter according to claim 4, characterized in that the screening element (4) is provided in the form of being welded to the bell (1), preferably by making use of an ultrasonic welding or bonding method.

6. The filter according to claim 1, characterized in that the body (1) at the same time constitutes the filter element (4).

7. The filter according to claim 6, characterized in that the filter body (1) is made of a sintered material.

8. The filter according to claim 7, characterized in that the sintered material is a sintered plastic material.

9. The filter according to claim 8, characterized in that the sintered plastic material is a polyethylene having an ultra-high molecular weight.

10. Filter according to any one of the claims 1 to 9, characterized by permeability in the range from 40 to 200 μm.

11. The filter according to claim 10, characterized by permeability ranging between 60 and 100 μm

12. Filter according to any one of the above claims, characterized in that the adapter (2) is provided with a hose connection nipple (5) having a sealing rib (6).

13. The filter according to claim 12, characterized in that the adapter (2) is connected to the body (1) by means of a plug-type connection (7).

14. The filter according to claim 13, characterized in that in body (1) a annular undercut or recess (8) is formed out that engages with a correspondingly shaped projection (9) of the adapter (2).

15. The filter according to claim 14, characterized in that the projection (9) of the adapter (2) is conically shaped and engages with a correspondingly formed out recess (8) arranged in the interior space (10) of the filter body (1).

16. Pressurized two-component can for paint material being provided with a filter in accordance with any one of the claims 1 to 15, with said filter being connected with the valve unit of the aerosol paint can via an ascending pipe.

17. The pressurized can according to claim 16, characterized by an inner casing that can be forced open from the outside and is located in the bottom section of the can.

18. The pressurized can according to claim 17, characterized in that the inner casing contains a cross-linking component.

19. The pressurized can according to claim 17 or 18, characterized in that the inner casing contains a polyamine or polyisocyanate.
